(19) United States
(12) Patent Application Publication
(10) Pub. No.: US 2018/0209198 A1
(43) Pub. Date: Jul. 26, 2018

(54) FLEXIBLE DOOR SAFETY LIGHT CURTAIN

(71) Applicant: Steven Leo Company, Boynton Beach, FL (US)

(72) Inventor: Steven Leo Company, Boynton Beach, FL (US)

(21) Appl. No.: 15/411,887

(22) Filed: Jan. 20, 2017

(51) Int. Cl. E05F 15/43; E05F 15/74; E05F 15/632; B66B 5/00; G01V 8/20

(52) U.S. Cl. CPC E05F 15/43; E05F 15/74; E05F 2015/436; B66B 5/0012; G01V 8/20; E05F 15/632

(57) ABSTRACT

A flexible transmitter light bar and a flexible receiver light bar may be used, in conjunction with a controller, to prevent or reverse closure of a door, such as an elevator door, when an object blocks the transmission of light from the transmitter light bar to the receiver light bar. By using flexible light bars, shipping costs, storage footprints and installation efforts are significantly reduced as compared to rigid light bars currently in use. The light bars may be applied with an adhesive and may further include one or more mounting holes. The light bars may be sealed to be water proof and permit easy cleaning thereof. The light bars may be useful in retrofit applications as well as in newly installed doors.

### BACKGROUND OF THE INVENTION

### 1. Field of the Invention

One or more embodiments of the invention relates generally to safety devices. More particularly, the invention relates to a door safety light curtain, usable on movable doors, such as elevator doors, that are formed in a flexible assembly for ease of installation, storage, packaging and shipping.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Elevator light curtains typically include a transmitter and a receiver for sending a light signal therebetween. When the light signal is broken, the doors of the elevator may be prevented from closing or may be caused to reopen, if the closing process has already commenced. The light signal is typically not visible to the human eye, such as a light signal in the infrared (IR) wavelength.

Typical elevator light curtains may include a plurality of lamps in a transmitter light bar sending a light signal toward a receiver light bar, where the receiver light bar detects the light transmission to know whether an obstruction is present to prevent closure of the elevator doors. A controller is typically mounted in the elevator cab for controlling the transmitter and receiver, receiving signals from the receiver and controlling the elevator doors according to the received signals.

Referring to FIGS. 1 through 3, a transmitter light bar 100 and a receiver bar 102 are formed as rigid members for attachment to an elevator 110. The elevator 110 has a door 112 that opens and closes to let people on and off the elevator cab 114. The transmitter light bar 100 sends a light signal 101 to the receiver bar 102 for detecting the presence of a person or object or the like in the path of the elevator door 112.

The transmitter light bar 100 and the receiver bar 102 are typically from about 70 to about 150 inches in length, often about 79.5 inches in length, for example. The bars 100, 102 each have a cable 104 and a connector 106 extending therefrom. The connectors 106 are configured to plug into a controller 108 for controlling operation of the elevator 110. Therefore, to ship the bars 100, 102, packaging must be configured to fit a length 122 of the bars 100, 102, plus the cable 104 and connectors 106. Often, this packaging is longer than 80 inches in length, dramatically increasing shipping costs for the bars 100, 102. Additionally, storage of such items, as shown in FIG. 3, requires a significant footprint.

In view of the foregoing, there is a need for a safety light bar that is made flexible to reduce shipping costs and require a smaller storage footprint.

### SUMMARY OF THE INVENTION

Embodiments of the present invention provide an apparatus for preventing undesirable closure of a door comprising a flexible transmitter light bar attached at one side of an opening closed by the door; a flexible receiver light bar attached at an opposite side of the opening; one or more lights disposed on the flexible transmitter light bar, the one or more lights delivering a light beam across the opening toward one or more receivers disposed on the flexible receiver light bar; and a controller receiving a signal from the flexible receiver light bar, the controller preventing closure of the door when the light beam is interrupted from being received by the one or more receivers.

Embodiments of the present invention further provide an apparatus for preventing undesirable closure of an elevator door comprising a flexible transmitter light bar attached at one side of an opening closed by the elevator door; a flexible receiver light bar attached at an opposite side of the opening; one or more lights disposed on the flexible transmitter light bar, the one or more lights delivering a light beam across the opening toward one or more receivers disposed on the flexible receiver light bar; and a controller receiving a signal from the flexible receiver light bar, the controller preventing closure of the door when the light beam is interrupted from being received by the one or more receivers, wherein the light beam covers over 50 percent of the opening.

Embodiments of the present invention also provide a method of preventing undesired closure of an elevator door, comprising emitting light beams from at least one light disposed on a flexible transmitter light bar attached at one side of an opening closed by the elevator door; receiving the light beams with at least one receiver disposed on a flexible receiver light bar attached at an opposite side of the opening; receiving a signal into a controller from the flexible receiver light bar, the controller preventing closure of the door when the light beams are interrupted from being received by the one or more receivers.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 shows a perspective view of rigid elevator curtain light bars and light signals generated therefrom, according to the prior art;

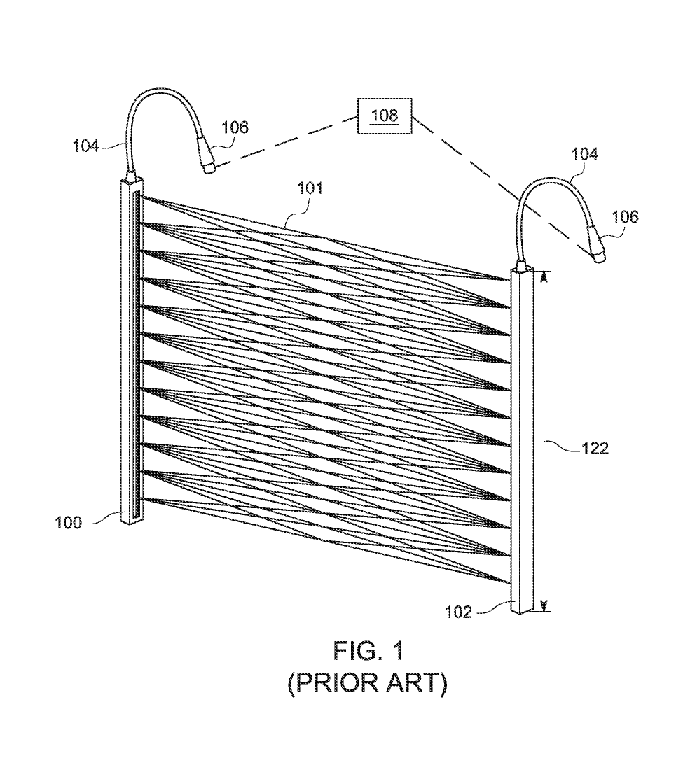

FIG. 2 shows an elevator door using the rigid elevator curtain light bars of FIG. 1;

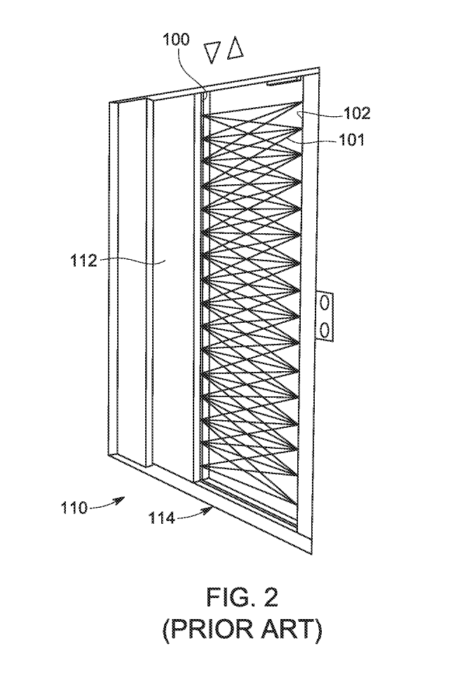

FIG. 3 shows a plurality of shipping tubes used for the rigid elevator curtain light bars of FIG. 1;

FIG. 4 shows a flexible transmitter light bar useful as a door safety light emitting element according to an exemplary embodiment of the present invention;

FIG. 5 shows a flexible receiver light bar useful as a door safety light emitting element according to an exemplary embodiment of the present invention;

FIG. 6 shows one exemplary packaging for the flexible light bars of FIGS. 4 and 5;

FIG. 7 shows a perspective view of the flexible light bars of FIGS. 4 and 5 and light signals generated and received therefrom, according to an exemplary embodiment of the present invention; and

FIG. 8 shows a schematic representation of a controller used for the flexible light bars of FIGS. 4 and 5.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a flexible transmitter light bar and a flexible receiver light bar that may be used, in conjunction with a controller, to prevent or reverse closure of a door, such as an elevator door, when an object blocks the transmission of light from the transmitter light bar to the receiver light bar. By using flexible light bars, shipping costs and storage footprints are significantly reduced and installation is improved as compared to rigid light bars currently in use. The light bars may be applied with an adhesive and may further include one or more mounting holes. The light bars may be sealed to be water proof and permit easy cleaning thereof. The light bars can include controlling circuitry built into the flexible strip. The light bars may be useful in retrofit applications as well as in newly installed doors.

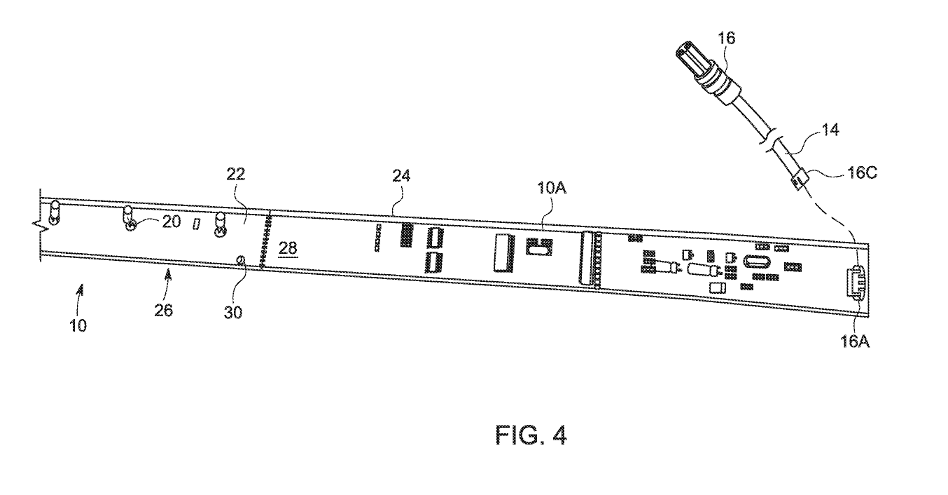

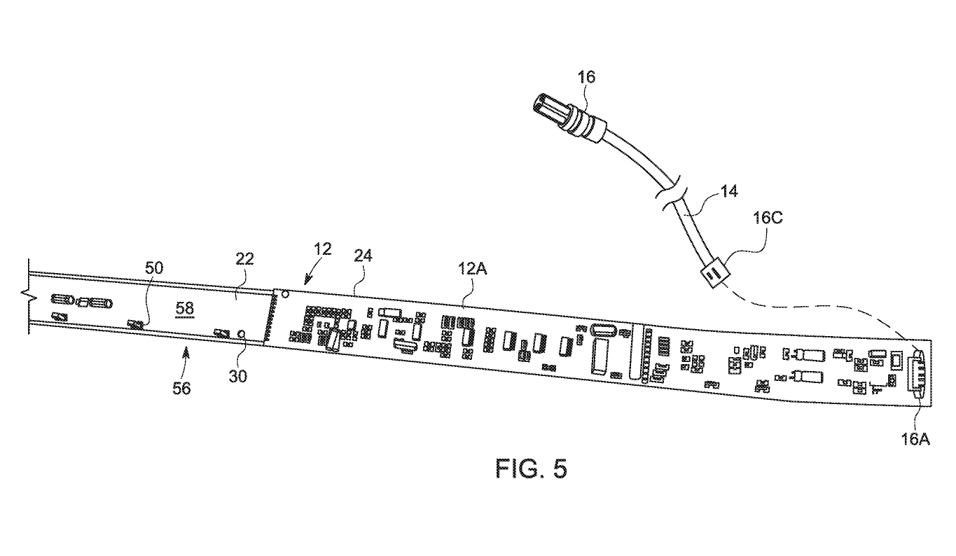

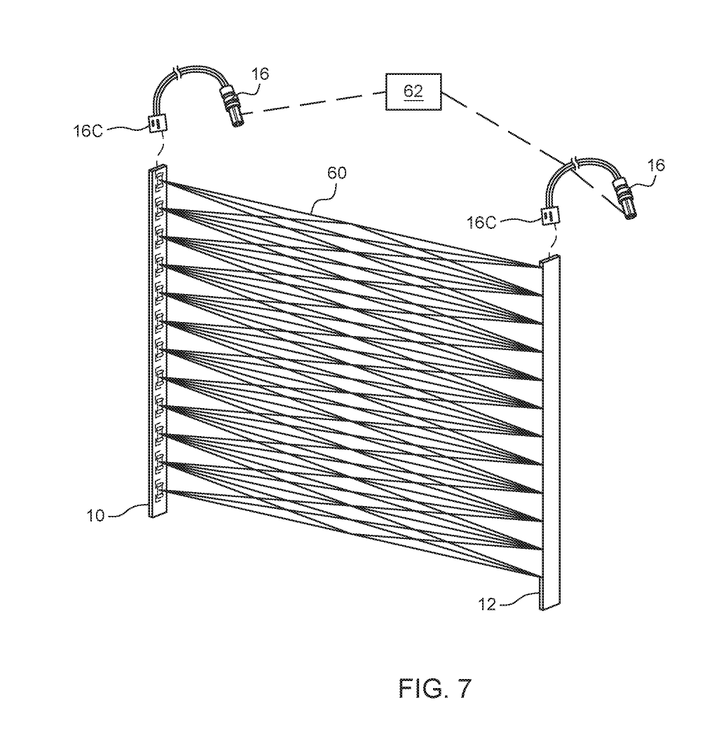

Referring to FIGS. 4 through 7, a transmitter light bar 10 may be used in conjunction with a receiver light bar 12, where light beams 60 may be sent from lights 20 on the transmitter light bar 10 to be received by receivers 50 on the receiver light bar 12. The light beams 60 may take various forms, but typically may be infrared light. While FIGS. 4 and 5 show the lights 20 and the receivers 50 as distinct elements along the light bars 10, 12, respectively, the lights 20 and receivers 50 may take various forms. For example, the lights 20 may be one or more elongated elements formed along the transmitter light bar 10. Similarly, the receivers 50 may be one or more elongated elements formed along the receiver light bar 12. While FIG. 7 shows the light beams 60 as distinct light beams, the light beams 60 may be focused or widened, depending on the particular application. For example, a single light 20 may direct its light beam 60 to one or more receivers 50. This may be helpful, for example, should one light 20 be non-functional, the receivers 50 may still receive light beams 60 from adjacent lights 20, avoiding a false indication of an object being in the path of the light beam 60.

Typically, the each light 20 along the light bar emits a light in turn, one at a time, and the appropriate receiver or receivers 50 detect each specific light 20. Typically each receiver 50 detects the light, one at a time, in sequence, along the receiver light bar 12. The pulsed light pattern may happen rapidly. In some embodiments, the lights 20 illuminate successively up or down the light bar 10. To achieve this action, the lights 20 are wired direct to the power source and not wired in parallel or series, where power is delivered to each light 20 separately and distinctly. In some embodiments, individual lights that illuminate may be replaced by multiple lights, however, each set of multiple lights are still wired so that they may illuminate separately in a pattern.

Typically, the lights 20 are light emitting diodes (LEDs) disposed along the transmitter light bar 10. The receivers 50 may be any light detecting devices, such as photo diodes, that can detect the presence or absence of light beams 60 being received thereby.

The light bars 10, 12 can include a circuitry region 10A, 12A typically at one end of thereof. The cable 14 may extend from one end of the circuitry region 10A, 12A or may plug in, via a connector 16C on the cable 14, to a connector 16A on the light bars 10, 12. This allows the cable 14 to be replaced without the need to remove and replace the light bars 10, 12.

The circuitry may be designed to provide the illumination of lights or the reception of lights and may be programmed to detect failure and/or non-reception of light. Typically, the non-reception of light may occur for a given number of illumination events before action (such as stopping a closing elevator door) may occur. In some embodiments, the receivers 50 may be sensed, one at a time, along the light bar 12.

The light bars 10, 12 can include a waterproof coating 22, such as a flexible epoxy coating, covering a top surface 28, 58 thereof. In some embodiments, the coating 22 may encapsulate the entire light bar 10, 12, except for the connector 16A. A bottom surface 26, 56 of the light bars 10, 12 may be a flat surface having an adhesive 24 formed thereupon for attaching the light bars 10, 12 to an elevator door. In some embodiments, one or more through holes 30 may be formed through the light bars 10, 12 for optionally securing the light bars 10, 12 to the elevator. Typically, at least one through hole 30 may be formed, for example, near opposite ends of the light bars 10, 12, as shown in FIGS. 4 and 5. The through hole 30 may be formed in various sizes. In some embodiments, the through holes 30 are not needed and the light bars 10, 12 can be applied simply with the adhesive 24.

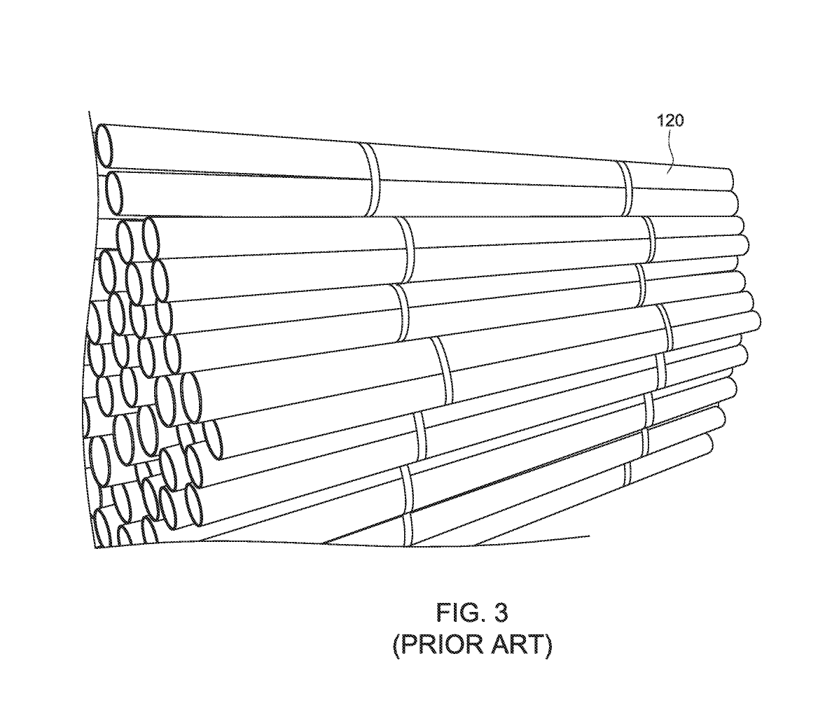

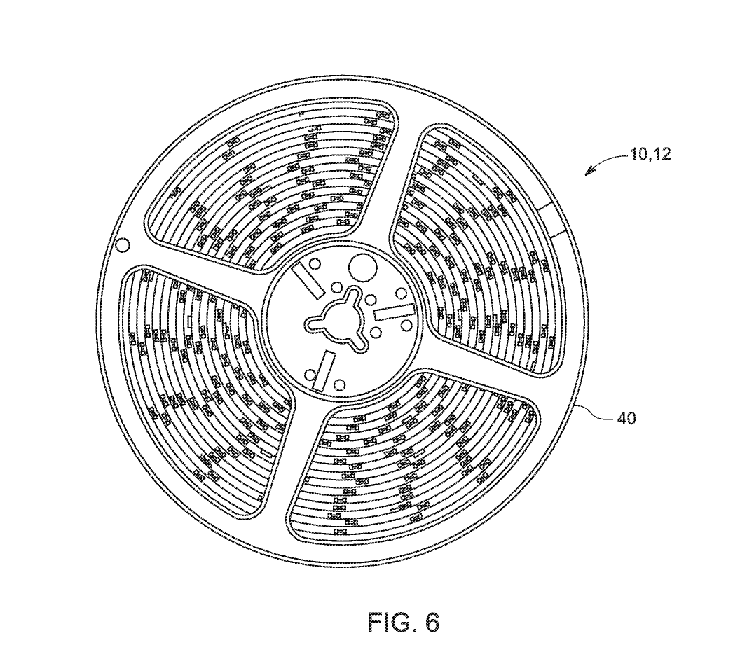

The light bars 10, 12 may be formed as elongated, flexible structures, wherein the light bars 10, 12 may be stored as a coil in a frame 40, as shown in FIG. 6. As can be readily appreciated, the frame 40 provides a significantly reduced footprint as compared to shipping tubes as shown in FIG. 3.

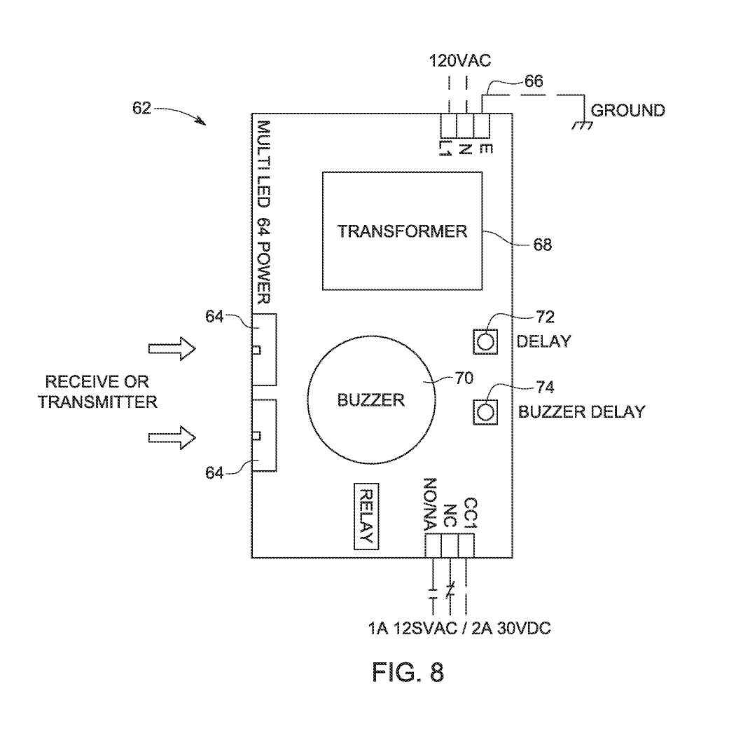

Referring to FIGS. 7 and 8, a power supply/relay box 62 may receive connectors 16 of the light bars 10, 12 into ports 64. Typically, the power supply/relay box 62 is carried on, in or atop the cab of the elevator, for example. The power supply/relay 62 may be powered by a standard power supply 66, such as a 120 VAC power source. The power received from the power supply 66 may be converted into suitable power for the light bars 10, 12, such as DC power, via a transformer 68. In some embodiments, the power supply/relay box 62 may include a buzzer delay 74 that may sound a buzzer 70 should the light beams 60 be blocked for a given period of time. A delay 72 may provide a time delay before closing the doors when the light beams 60 are broken.

In operation, the light bars 10, 12 may be affixed to the elevator (or other door closing structure) so that light from the transmitting light bar 10 is received by the receivers 50 of the receiver light bar 12. The light bars 10, 12 are connected to the power supply/relay box 62 so that when one or more of the receivers 50 are not receiving light (such as IR light from the lights 20 of the transmitting light bar 10), the power supply/relay box 62 may cease closing of the doors, open the doors, and/or prevent the doors from closing. When the receivers 50 begin to receive the light beams 60, the doors may operate as normal and closing may be permitted.

While the above description focuses on elevator doors, embodiments of the present invention may be useful in any situation where inadvertent or undesired closing of a door is beneficial. These situations may include any door that has a controlled closing mechanism where the closing mechanism may be interrupted or reversed when an object is detected in the door's path. Such doors may include overhead doors, security doors and screens, dumb waiter-type structure doors, motorized sliding doors, and the like.

The light bars 10, 12 may be used together, or, for example, if only the transmitter light bar or the receiver light bar needs replacement, the flexible light bars of the present invention may be used with a conventional rigid light bar. For example, should a conventional rigid light detector fail, a user may only need to replace the defective detector with the receiver light bar 12 of the present invention, using the original transmitter light bar therewith. Moreover, the light bars 10, 12 may be configured to be used with standard elevator door controllers, or may be designed for use with the controller 62 as herein described.

The number of lights 20 and receivers 50 may vary depending on the size of the door and the particular application. In some embodiments, one or more lights 20 and receivers 50 are disposed on the light bars 10, 12. Typically, at least 10 lights 20 and at least 10 receivers 50 are disposed on the light bars 10, 12. Often, 20 or more lights 20 and 20 or more receivers 50 are disposed on the light bars 10, 12. In some embodiments, the number of lights 20 may be configured to create a “light curtain” in the opening that the door closes. Typically this light curtain will cover at least 50% of the opening, often at least 80% of the opening, where any interruption of the light beam in the light curtain is measured by the receiver light bar to cause the controller to prevent closure of the door.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An apparatus for preventing undesirable closure of a door comprising:
a flexible transmitter light bar attached at one side of an opening closed by the door;
a flexible receiver light bar attached at an opposite side of the opening;
two or more lights disposed on the flexible transmitter light bar, the two or more lights delivering a light beam in a pattern across the opening toward two or more receivers disposed on the flexible receiver light bar; and
circuitry receiving a signal from the flexible receiver light bar, the circuitry providing a signal to prevent closure of the door when the light beam is interrupted from being received by the one or more receivers.

2. The apparatus of claim 1, wherein the two or more lights include a plurality of lights.

3. The apparatus of claim 1, wherein the two or more receivers include a plurality of receivers.

4. The apparatus of claim 1, further comprising at least one through hole formed through the flexible transmitter light bar and the flexible receiver light bar, the at least one through hole receiving an attachment member therethrough for attaching the flexible transmitter light bar and the flexible receiver light bar to the respective sides of the opening.

5. The apparatus of claim 1, wherein the transmitter light bar and the receiver light bar are each from about 70 to about 150 inches in length.

6. The apparatus of claim 1, further comprising a first connector electrically attached to the transmitter light bar and a second connector attached to the receiver light bar, the first and second connectors electrically connecting the transmitter and receiver light bars to a power supply.

7. The apparatus of claim 1, wherein the door is an elevator door.

8. The apparatus of claim 1, wherein the light beam covers at least 50% of the opening.

9. The apparatus of claim 1, wherein the pattern illuminates each of the two or more lights successively and independently.

10. An apparatus for preventing undesirable closure of an elevator door comprising:
a flexible transmitter light bar attached at one side of an opening closed by the elevator door;
a flexible receiver light bar attached at an opposite side of the opening;
two or more lights disposed on the flexible transmitter light bar, the two or more lights separately and independently delivering a light beam across the opening toward two or more receivers disposed on the flexible receiver light bar; and
circuitry receiving a signal from the flexible receiver light bar, the circuitry providing a signal to prevent closure of the door when the light beam is interrupted from being received by the one or more receivers, wherein
the light beam covers over 50 percent of the opening, and
the circuitry is formed integrally with the flexible receiver light bar.

11. The apparatus of claim 10, further comprising at least one through hole formed through the flexible transmitter light bar and the flexible receiver light bar, the at least one through hole receiving an attachment member therethrough for attaching the flexible transmitter light bar and the flexible receiver light bar to the respective sides of the opening.

12. The apparatus of claim 10, wherein the transmitter light bar and the receiver light bar are each from about 70 to about 90 inches in length.

13. The apparatus of claim 10, further comprising a first connector electrically attached to the transmitter light bar and a second connector attached to the receiver light bar, the first and second connectors electrically connecting the transmitter and receiver light bars to a power supply.

14. A method of preventing undesired closure of an elevator door, comprising:
emitting light beams from at least two lights disposed on a flexible transmitter light bar attached at one side of an opening closed by the elevator door;
receiving the light beams with at least two receivers disposed on a flexible receiver light bar attached at an opposite side of the opening;
receiving a signal into circuitry from the flexible receiver light bar, the circuitry preventing closure of the door when the light beams are interrupted from being received by the one or more receivers.

15. The method of claim 14, wherein the light beams cover at least 50% of the opening.

16. The method of claim 14, wherein the at least two lights include a plurality of lights.

17. The method of claim 14, wherein the at least two receivers include a plurality of receivers.

18. The method of claim 14, further comprising mounting the flexible transmitter light bar and the flexible receiver light bar with at least one through hole formed through the flexible transmitter light bar and the flexible receiver light bar, the at least one through hole receiving an attachment member therethrough for attaching the flexible transmitter light bar and the flexible receiver light bar to the respective sides of the opening.

19. The method of claim 14, wherein the transmitter light bar and the receiver light bar are each from about 70 to about 150 inches in length.

20. The method of claim 14, further comprising illuminating each of the two or more lights independent in a pattern.
